(19) United States
(12) Patent Application Publication
(10) Pub. No.: US 2006/0166533 A1
(43) Pub. Date: Jul. 27, 2006

(54) Card connector

(76) Inventors: Hidenori Muramatsu, Kanagawa (JP); Satoru Watanabe, Tokyo (JP)

Correspondence Address: BARLEY SNYDER, LLC, 1000 WESTLAKES DRIVE, SUITE 275, BERWYN, PA, 19312, US

(21) Appl. No.: 11/339,420

(22) Filed: Jan. 25, 2006

(30) Foreign Application Priority Data
Jan. 25, 2005 (JP) 2005-17254

(51) Int. Cl. H01R 13/62

(52) U.S. Cl. 439/160

(57) ABSTRACT

The invention is a compact card connector having an ejection mechanism that enables a push push operation, which can reliably achieve an operation which is such that the push button cannot protrude from the housing unless a card is inserted into a specified position. The card connector comprises a movement restricting mechanism for the push bar for allowing the movement of the cam pin along the cam groove when the card is inserted into a specified position. The movement restricting mechanism comprises a bracket that is attached to the guide arm and a movement restricting member that is attached to the bracket so that swinging is possible, thus restricting the movement of the push bar when the card is not inserted, and releasing the restriction on the movement of the push bar as a result of swinging when the card is inserted into the specified position.

### FIELD OF THE INVENTION

The present invention relates to a card connector which has an ejection mechanism for push push operation.

### BACKGROUND

The card connector shown in FIG. 15 (see JP2001-267013A), for example, is a known push push card connector. This card connector 101 comprises an insulating housing 110 that has a pair of guides 111 for guiding a card (not shown in the figure), a plurality of contacts that are held in the housing 110, and a push push type ejection mechanism 130 that is disposed on the side of one of the guides 111 that is used to eject the card.

The ejection mechanism 130 comprises an ejection lever 131 that ejects the card by being attached to one of the guides 111 so that this ejection lever 131 can slide, a spring member 132 that biases this ejection lever 131 in the direction of card ejection, and a cam follower 133. The ejection lever 131 has an ejection arm 131a that is pushed by the tip end of the card when the card is inserted and that pushes the tip end of the card when the card is ejected. A heart shaped cam groove 134 is formed in the side surface of this ejection lever 131. Furthermore, the cam follower 133 is shaft supported on one of the guides 111 of the housing 110 so that this cam follower 133 can pivot through a specified angle, and a guide pin 133a that engages with the cam groove 134 is provided at the tip end of this cam follower 133. The mechanism is arranged so that the sliding of the ejection lever 131 is restricted by the engagement of the cam groove 134 formed in the ejection lever 131 and the guide pin 133a of the cam follower 133 so as to be pivotable through a specified angle.

In cases where no card is inserted in this card connector 101, the guide pin 133a of the cam follower 133 is located in a recessed part 134a at the rear end (right end portion in FIG. 15) of the cam groove 134, and the ejection lever 131 is located in a position protruding fartherest to the front.

Furthermore, when a card is inserted from the front side of the housing 110, and the tip end of this card contacts the ejection arm 131a, the card and ejection lever 131 retract as an integral unit to the interior of the card connector 101 while resisting the biasing force of the spring member 132. At this point, the guide pin 133a moves from the recessed part 134aof the cam groove 134, and is located in a groove 134b on one side.

Next, when the card is pushed to the maximum stroke and this pushing is then stopped, the card and the ejection lever 131 advance slightly by means of the restoring force of the spring member 132, so that the guide pin 133a is located in a recessed part 134c at the front end of the cam groove 134. As a result, the card insertion operation is completed.

Furthermore, when the card is pushed to the maximum stroke and this pushing is then stopped again, the guide pin 133a moves out of the recessed part 134c, and reaches the rear-end recessed part 134a via the other groove 134d. The card and ejection lever 131 advance by means of the biasing force of the spring member 132, so that the card is ejected. At this point, the ejection lever 131 is located in the initial state, i.e., in the most advanced position.

Moreover, the card connector shown in FIGS. 16 and 17A and 17B (see JP2002-324623A, is another known example of a card connector having an ejection mechanism that enables a push push operation. This card connector 201 comprises a frame 210 that guides a card C so that this card can be inserted and removed, a push push type ejection mechanism 220 that is provided on one side of the frame 210, and an ejection lever 230 that pivots by receiving the pressing force of a push rod of the ejection mechanism 220 and that ejects the inserted card C.

Here, the push rod has a first rod 221 that receives the pressing force from the operator and a second rod 222 that transmits this pressing force to the ejection lever 230. A cam member 250 that engages with a guide groove 241 formed in a guide plate 240 is provided at the tip end of the first rod 221 that faces the second rod 222, so that the first rod 221 and second rod 222 are linked via the cam member 250 during the ejection of the card C. The cam member 250 is driven in the card ejection direction by a tension spring 253. Furthermore, in FIG. 17B, the symbol 251 indicates a locking part that locks the tension spring 253, and 252 indicates an engaging part that engages with the guide groove 241.

Problems have been encountered in these conventional card connectors 101 and 201. Specifically, in the case of the card connector 101 shown in FIG. 15, in a state in which no card is inserted, i.e., in a state prior to a card contacting the ejection lever 131, the ejection lever 131 is located in the most advanced position. Accordingly, there is a possibility that the ejection lever 131 protrudes from a housing of a personal computer or the like on which the card connector 101 is installed, so that there is a danger that the ejection lever 131 will be damaged by side impact or the like. Furthermore, if the ejection lever 131 protrudes from the housing, there are cases in which the user will perform an erroneous operation. On the other hand, in a state in which no card is inserted, i.e., in a state prior to the card contacting the ejection lever 131, it is also possible to push the ejection lever 131 and to cause the guide pin 133a to be positioned in the front-end recessed part 134c of the cam groove 134, so that the ejection lever 131 is located in the retracted position. However, it is possible to further push the ejection lever 131 in this state; as a result, there is a danger that the guide pin 133a will move out of the front-end recessed part 134c, and reach the rear-end recessed part 134a via the second groove 134d, so that the ejection lever 131 will end up being located in the most advanced position.

In the case of the card connector 201 shown in FIGS. 16 and 17A and 17B, furthermore, in a state in which the card C is not inserted, a push button 223 that is attached to the first rod 221 does not protrude from the housing, and even if the push button 223 is pressed, this push button 223 does not protrude from the housing. However, the cam member 250 that links the first rod 221 and second rod 222 during the ejection of the card C is manufactured by stamping a metal plate and subsequently forming this metal plate. Accordingly, it is difficult to achieve dimensional precision, and this cam member may not function in a normal manner as a cam member due to a slight dimensional deviation or an assembly error during assembly, so that there are cases in which the push button 223 that is attached to the first rod 221 protrudes from the housing in a state in which the card C is not inserted.

### SUMMARY

Accordingly, the present invention was devised in light of the problems described above. It is an object of the present invention, among other objects, to provide a compact card connector having an ejection mechanism which enables a push push operation that reliably makes it possible for the push button to act so that this push button cannot protrude from the housing unless a card is inserted into a specified position.

The invention is embodied in a card connector having a connector that has a guide arm for guiding a card so that this card can be inserted and removed and a card ejection mechanism for ejecting the card that is inserted into this connector by means of a push push operation. The card ejection mechanism has a pivoting arm that is disposed in the connector in a pivotable manner and that ejects the card in the removal direction as a result of pivoting. A push bar has a push button and is capable of moving in the card insertion and removal directions along the side surface of the guide arm. A push plate that is shaft supported on the push bar in a pivotable manner pushes and causes the pivoting arm to pivot during the ejection of the card. The card connector is further provided with a cam mechanism consisting of a heart-shaped cam groove that is formed in the side surface of the guide arm and a cam pin that is provided on the push plate and engages with the cam groove. A movement restricting mechanism for the push bar allows the movement of the cam pin along the cam groove when the card is inserted into a specified position. This movement restricting mechanism comprises a bracket that is attached to the guide arm, and a movement restricting member that is attached to the bracket in a manner allowing it to swing out from the bracket. The movement of the push bar is thus restricted when the card is not inserted, and this restriction on the movement of the push bar is released as a result of movement restricting member swinging when the card is inserted into the specified position.

### BRIEF DESCRIPTION OF THE DRAWINGS

The invention will now be described in more detail with reference to the accompanying figures showing an embodiment wherein:

FIG. 1 is a perspective view of a card connector as seen from above on the right from the front surface with a card prior to insertion;

FIG. 2 is a perspective view of the card connector of FIG. 1 as seen from above on the left from the front surface with a card prior to insertion;

FIGS. 3A to 3D show the card connector of FIG. 1, with FIG. 3A being a plan view, FIG. 3B being a front view, FIG. 3C being a back view, and FIG. 3D being a bottom view;

FIGS. 4A and 4B show the card connector of FIG. 1, with FIG. 4A being a right side view, and FIG. 4B being a left side view;

FIG. 5 is a perspective view of the card connector of FIG. 1 in a state in which the guide arm has been removed;

FIG. 6 is a front perspective view of the push bar, push rod, and push button which make up a card ejection mechanism, and a movement restricting mechanism for the push bar;

FIG. 7 is a rear perspective view of the push rod and push button which make up the card ejection mechanism, and the movement restricting mechanism for the push bar;

FIG. 8 is a perspective view of the movement restricting mechanism for the push bar as;

FIG. 9 is an exploded perspective view of the movement restricting mechanism for the push bar;

FIG. 10 is a rear perspective view of the movement restricting mechanism for the push bar;

FIGS. 11A to 11F are explanatory diagrams of the action of the cam mechanism;

FIGS. 12A and 12B are explanatory diagrams of the action of the cam mechanism;

FIG. 13 is a plan view of the card connector when no card is inserted;

FIG. 14 is a plan view of the card connector when a card is inserted into a specified position;

FIG. 15 is a perspective view of a conventional example of a card connector which has an ejection mechanism enabling a push push operation;

FIG. 16 is a perspective view of another conventional example of a card connector which has an ejection mechanism enabling a push push operation; and

FIGS. 17A and 17B display essential parts of the ejection mechanism of the card connector shown in FIG. 16, with FIG. 17A being a plan view, and FIG. 17B being a side view.

### DETAILED DESCRIPTION OF THE EMBODIMENT(S)

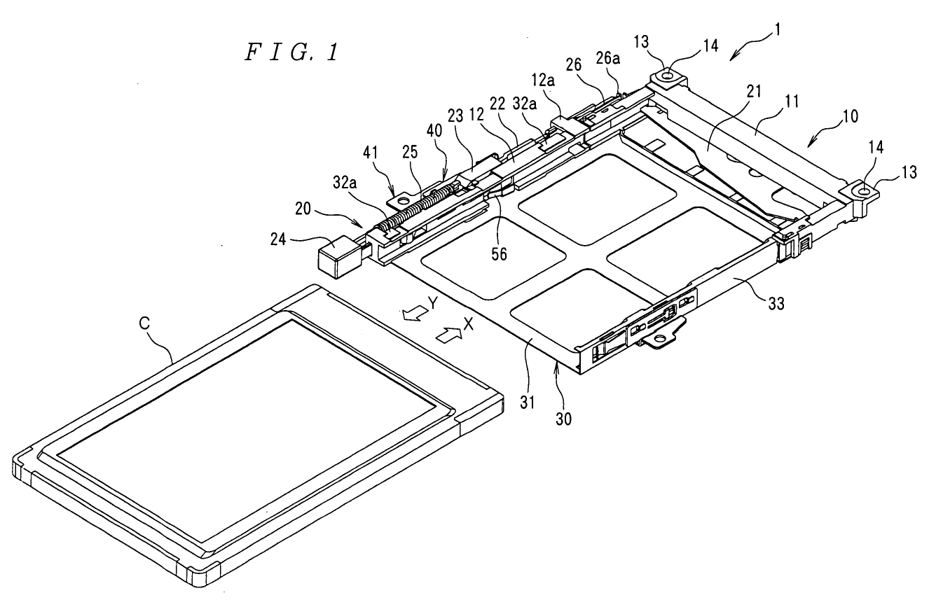

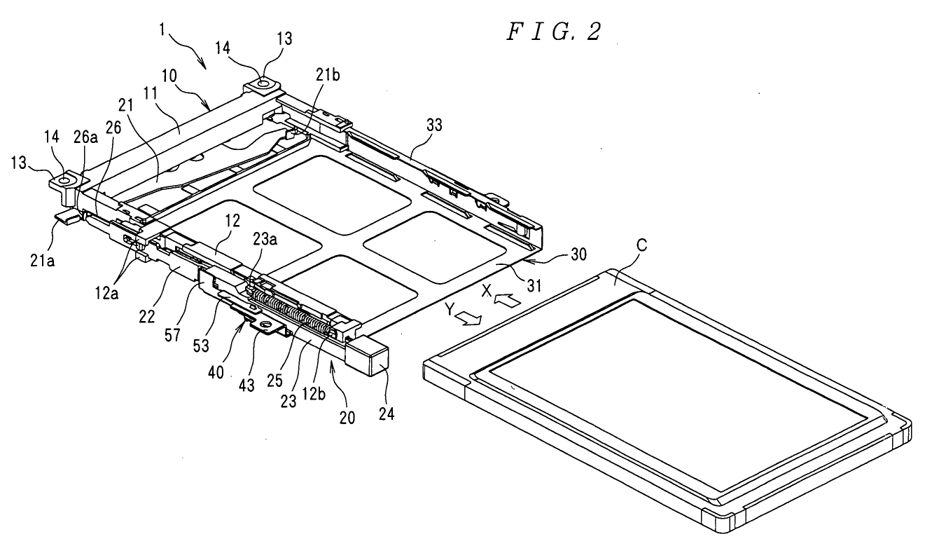

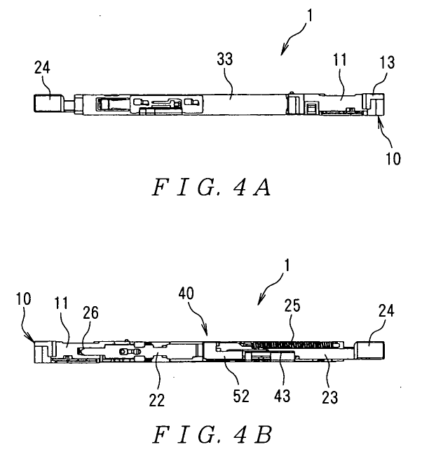

Next, an embodiment of the present invention will be described with reference to the figures. In FIGS. 1, 2, 3A to 3D, and 4A and 4B, the card connector 1 comprises an electrical connector 10 and a card ejection mechanism 20. The connector 10 is devised so that a card C is inserted into this connector 10 in the direction of arrow X shown in FIG. 1, and so that the card C that is inserted in this connector 10 is removed in the direction of arrow Y shown in FIG. 1. Hereinafter, the direction of arrow X is referred to as the card insertion direction, and the direction of arrow Y is referred to as the card removal direction. Furthermore, the interior side in the card insertion direction is referred to as the rear side, and the opposite side is referred to as the front side.

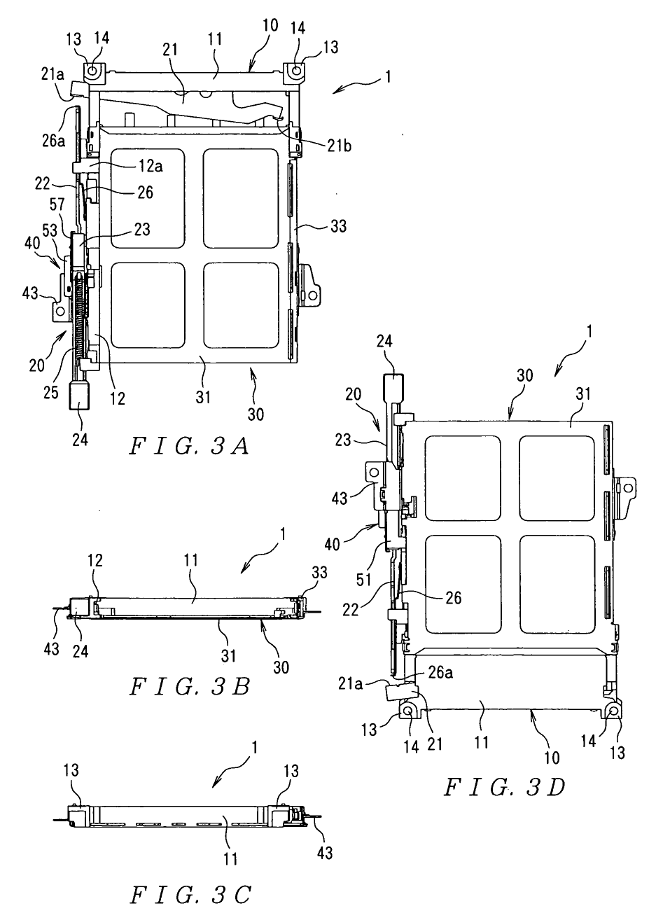

The connector 10 comprises a housing 11 that is a substantially rectangular body extending in the direction of length, which is defined here as perpendicular to the card insertion direction and a plurality of contacts (not shown in the figures) that are held along the length of the housing 11. The housing 11 is formed by molding an insulating material, and a guide arm 12 that protrudes toward the card removal direction is attached to the left side of the housing 11. Furthermore, a metal frame 30 which has a bottom plate 31 and side plates 32 and 33 that are provided on both the left and right edges (on both the left and right edges in FIG. 3A) of this bottom plate 31 is attached to the bottom side of the guide arm 12 and housing 11. The metal frame 30 is attached to the housing 11 at the rear end of the left and right side plates 32 and 33, and is also attached to the guide arm 12 by a plurality of locking projections 32a that are provided on the left side plate part 32. Moreover, this card connector 1 is devised so that the card C is guided by the inner surface of the guide arm 12 and the inner surface of the right side plate 33 of the metal frame 30 so as to allow the insertion and removal of this card C. Furthermore, board mounts 13 for mounting this card connector on a circuit board (not shown in the figures) are provided on both the left and right end parts of the housing 11, and a through hole 14 for an attachment screw is formed in each of the board mounts 13. In addition, each contact is formed by stamping and forming a metal plate, and is designed to be connected by soldering to the circuit board and to make mating contact with the card C that is inserted into the connector 10.

The card ejection mechanism 20 comprises a pivoting arm 21 that is disposed in the housing 11 in a pivotable manner, a push bar 22 that is capable of moving in the card insertion direction and in the card removal direction along the outer surface of the guide arm 12, and a push plate 26 that is shaft supported on the push bar 22 in a pivotable manner and that pushes and causes the pivoting arm 21 to pivot during the ejection of the card C.

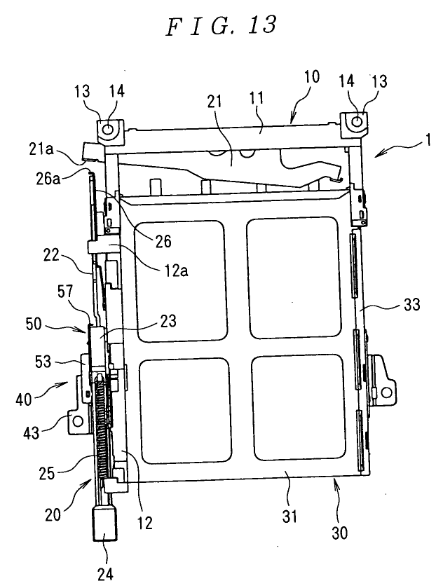

The pivoting arm 21 is disposed inside the housing 11 in a pivotable manner, and comprises a card engagement surface 21b that engages with the inserted card C at one end and also comprises a plate engaging section 21a (FIG. 13) that engages with an engagement part 26a (described later) of the push plate 26 at the other end on the outside of the housing 11. The pivoting arm 21 is designed to eject the inserted card C in the card removal direction by pivoting.

The push bar 22 extends in the forward-rearward direction, and is formed by stamping and forming a metal plate. The push bar 22 is disposed along the outer surface of the guide arm 12 and supported to be movable in the card insertion direction and removal direction by a pair of upper and lower locking claws 12a that protrude outward from the rear portion of the guide arm 12. A push rod 23 is fastened to the front end portion of the push bar 22, and a push button 24 is provided on the front end portion of this push rod 23. A first spring locking part 23a is provided on the push rod 23, while a second spring locking part 12b is provided on the guide arm 12. A tension spring 25 is attached to the first spring locking part 23a and second spring locking part 12b so that the push bar 22 is biased in the card removal direction.

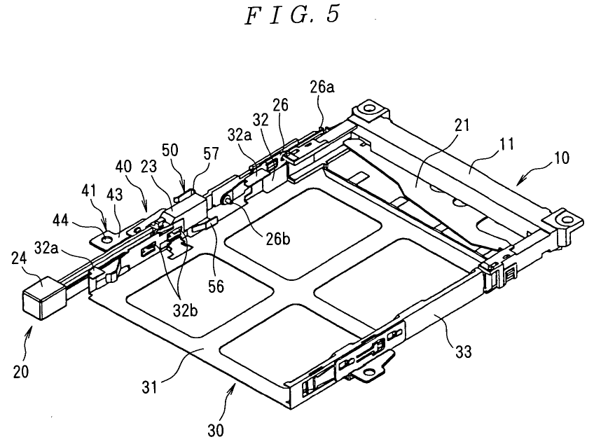

The push plate 26 extends in the forward-rearward direction, and is formed by stamping and forming a metal plate. The push plate 26 is disposed in a pivotable manner with respect to the push bar 22 along the inside of the push bar 22. The engagement part 26a that engages with the plate engaging section 21a of the pivoting arm 21 during the ejection of the card C is formed on the rear end portion of the push plate 26. Furthermore, as is shown in FIG. 5, a cam pin 26b is attached to the front end portion of the push plate 26 so that this cam pin 26b protrudes inward.

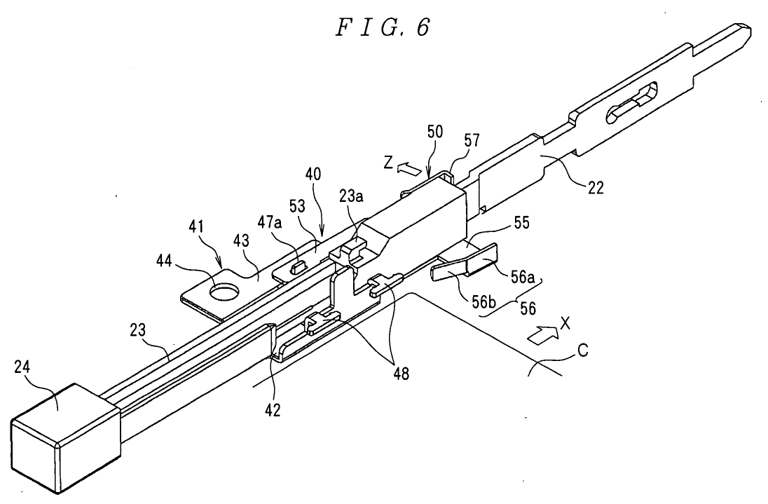

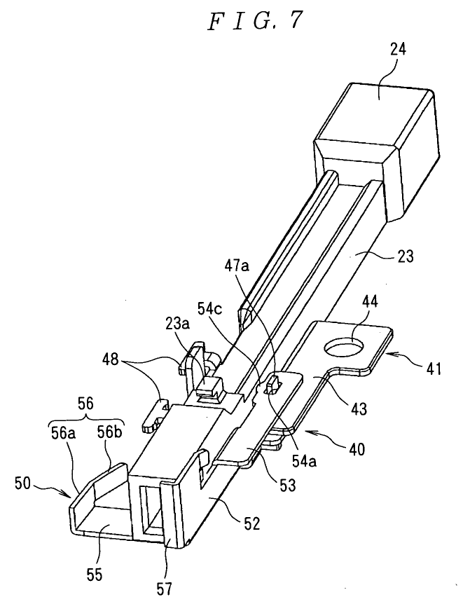

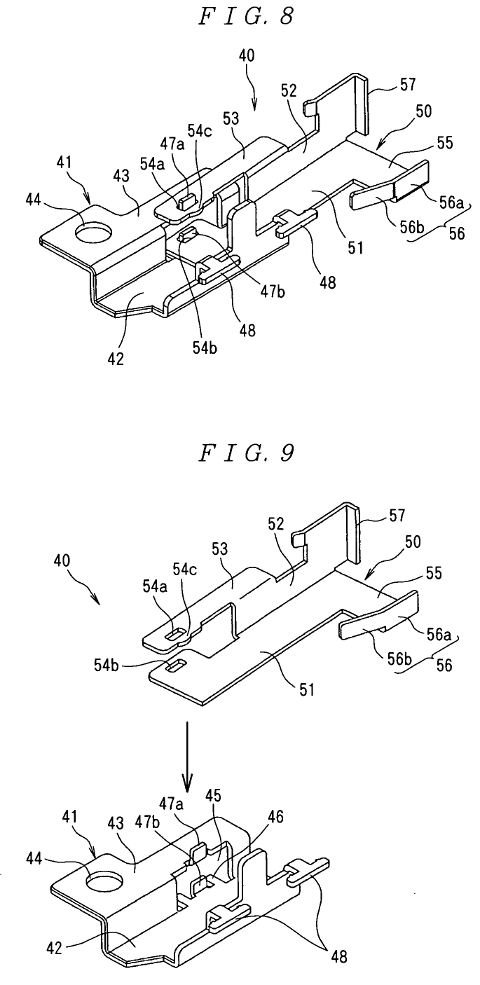

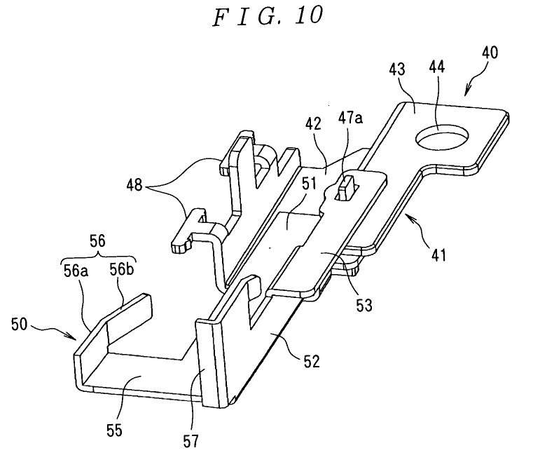

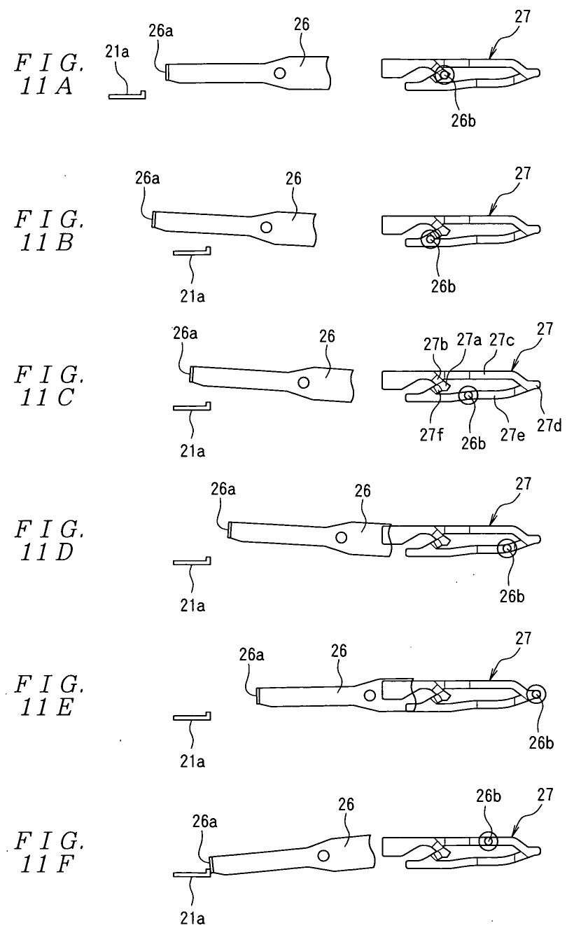

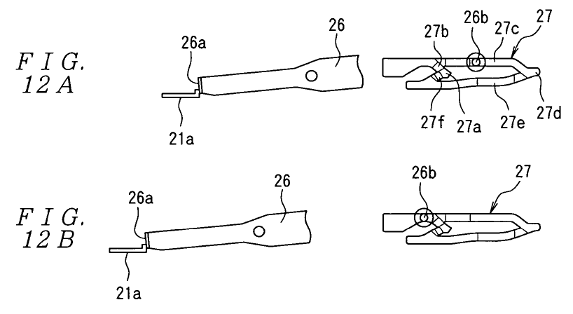

FIG. 6 is a perspective view of the push bar 22, push rod 23, and push button 24 which make up the card ejection mechanism 20, and a movement restricting mechanism 40 for the push bar 22. FIG. 7 is a perspective view of the push rod 23 and push button 24 which make up the card ejection mechanism 20, and the movement restricting mechanism 40 for the push bar. FIG. 8 is a perspective view of the movement restricting mechanism 40 for the push bar as seen from the front at an inclination from above. FIG. 9 is an exploded perspective view of the movement restricting mechanism 40 for the push bar. FIG. 10 is a perspective view of the movement restricting mechanism 40 for the push bar as seen from the rear at an inclination from above. FIGS. 11A to 11F are explanatory diagrams of the action of the cam mechanism. FIGS. 12A and 12B are explanatory diagrams of the action of the cam mechanism.

As is shown in FIGS. 11A to 11F and 12A and 12B, a heart-shaped cam groove 27 with which the cam pin 26b engages is formed in the outer surface of the guide arm 12. As is shown in FIG. 11C, the cam groove 27 comprises a rear side recessed part 27a that is formed substantially in the central portion of the guide arm 12, a first rectilinear part 27b that extends upward toward the rear from this rear side recessed part 27a, and a second rectilinear part 27c that first extends rearward from the tip end of the first rectilinear part 27b and then extends forward. Furthermore, a front side recessed part 27d is formed to extend downward toward the front from the front end of the second rectilinear part 27c. Moreover, a substantially rectilinear part 27e that extends downward obliquely toward the rear from the front side recessed part 27d and then extends rearward is formed, and a third rectilinear part 27f extends from the rear end of this substantially rectilinear part 27e toward the rear side recessed part 27a. Accordingly, the cam groove 27 is formed in a heart-shaped loop. This heart-shaped cam groove 27 that is formed in the outer surface of the guide arm 12 and the cam pin 26b that engages with the cam groove 27 make up the cam mechanism, and this cam mechanism makes it impossible to reverse the pulling operation of the push bar 22 and push plate 26 in the card removal direction and the pressing operation of the push bar 22 and push plate 26 in the card insertion direction. In other words, the cam pin 26c moves in one direction along the cam groove 27 and goes around the cam groove 27; the cam pin 26c does not move in the opposite direction.

Furthermore, a movement restricting mechanism 40 for the push bar 22 is attached to the outer surface of the guide arm 12. The movement restricting mechanism 40 comprises a bracket 41 that is attached to the outer surface of the guide arm 12 substantially in the central portion in the forward-rearward direction, and a movement restricting member 50 that is attached to the bracket 41 so that swinging in the outward direction is possible, thus restricting the movement of the push bar 22 in the card insertion direction when the card C is not inserted, and releasing this restriction on the movement of the push bar 22 as a result of swinging in the outward direction when the card C is inserted into a specified position. As a result, the movement of the cam pin 26b along the cam groove 27 is made possible when the card C is inserted into the specified position. The restriction on the movement of the push bar 22 in the card ejection direction during the non-insertion of the card C is accomplished by the cam pin 26b being entered in the rear side recessed part 27a of the cam groove 27.

Here, as is shown in FIGS. 6 through 10, the bracket 41 comprises a recessed plate 42 that allows the movement of the push rod 23 in the card insertion direction and ejection direction and a flat plate 43 that extends outward from the upper end of the side wall of the recessed plate 42 on the outside of this recessed plate 42. The bracket 41 is formed by stamping and forming a metal plate. An attachment hole 44 for attaching the card connector 1 to the surface of a circuit board is formed in the flat plate 43. Furthermore, an opening 45 is formed in the side wall on the outside of the recessed plate 42, and a first projection 47a is formed so as to protrude upward from the edge of the flat plate 43 on the side of the opening 45. Moreover, an extension plate 46 that protrudes outward from the bottom portion of the recessed plate 42 via the opening 45 is provided, and a second projection 47b is formed on this extension plate 46 so as to protrude upward. Meanwhile, a plurality of locking projections 48 that extend inward are provided on the side wall on the inside of the recessed plate 42. As is shown in FIG. 5, the locking projections 48 are designed to respectively pass through holes 32b that are formed in the left side plate part 32 of the metal frame 30 and to be locked with the outer surface of the guide arm 12 substantially in the central portion in the forward-rearward direction.

Furthermore, as is shown in FIGS. 8 through 10, the movement restricting member 50 comprises a flat plate 51 that is positioned on the bottom portion of the recessed plate 42 of the bracket 41, and is formed by stamping and forming a metal plate. A side wall 52 rises from the outer edge of the flat plate 51, and an extension plate 53 extends outward from the upper end of the side wall 52. Moreover, a second opening 54b which the second projection 47b of the bracket 41 enters is formed in the flat plate 5 1, and a first opening 54a which the first projection 47a of the bracket 41 enters is formed in the extension plate 53. In addition, as is clearly shown in FIG. 7, a semi-circular projection 54c that makes sliding contact with the outer surface of the push rod 23 is provided on the inner edge of the extension plate 53. Furthermore, as is shown in FIG. 6, a stop shoulder 57 that restricts the movement of the push rod 23 in the card insertion direction when the card C is not inserted is formed at the rear end portion of the side wall 52 by bending this rear end portion inward. Meanwhile, an inward extension plate 55 that extends inward is provided on the inner edge of the flat plate 51, and a swing plate 56 is provided on the innermost end of the inward extension plate 55. The swing plate 56 comprises a riser 56a that rises upward from the innermost end of the inward extension plate 55 and extends in the forward-rearward direction, and an inclined tongue 56b that extends forward outward from the riser 56a. When the card C is inserted into the specified position, one corner portion of the card C makes sliding contact with the inclined tongue 56b; as a result, the movement restricting member 50 swings in the outward direction (i.e., in the direction of arrow Z in FIG. 6) using the first projection 47a and second projection 47b as the pivot, so that the restriction on the movement of the push rod 23 in the card insertion direction is released. Furthermore, when the side surface of the card C reaches the position where this side surface makes sliding contact with the riser 56a, the swinging of the movement restricting member 50 is stopped. Then, when the card C is ejected, the movement restricting member 50 swings in the inward direction using the first projection 47a and second projection 47b as the pivot, and returns to the original position.

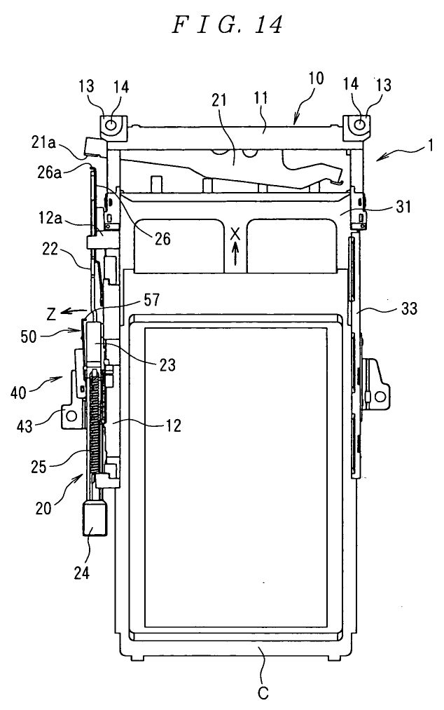

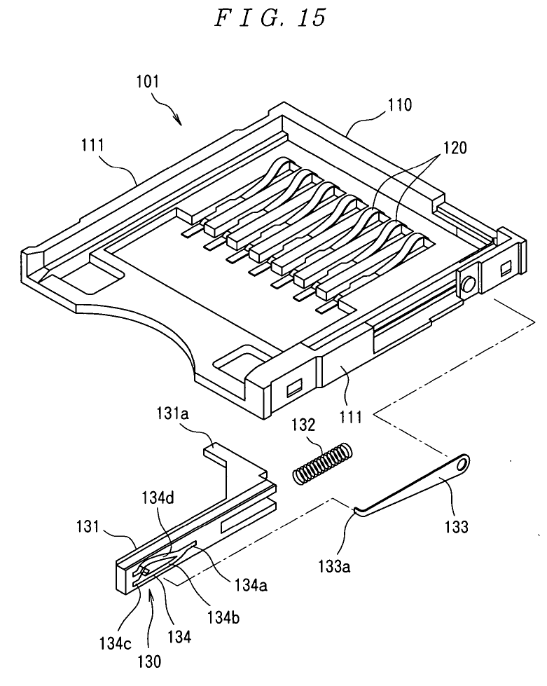

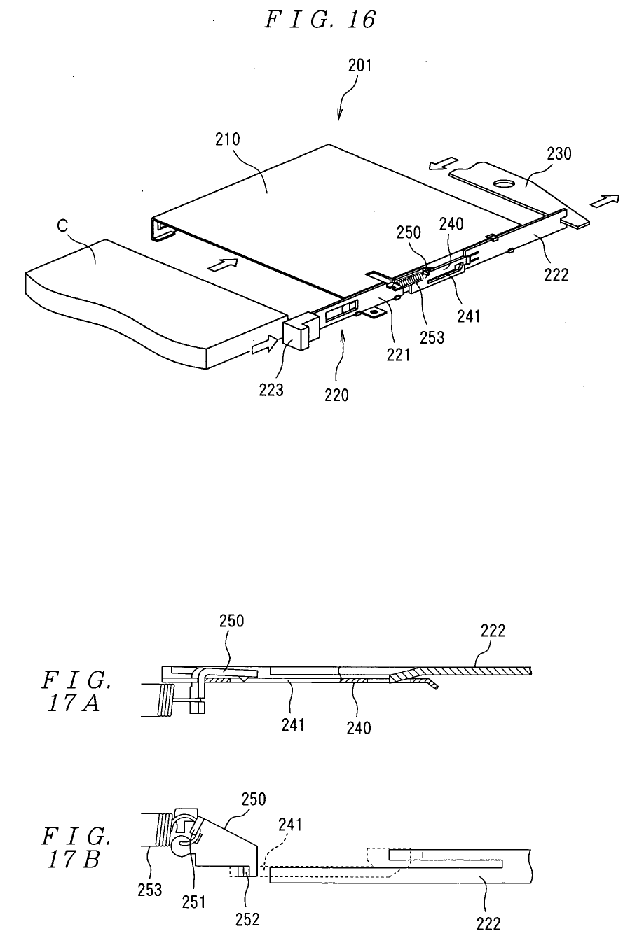

Next, the operation of the present invention will be described with reference to FIGS. 11 A to 1 F, 12A and 12B, 13 and 14. FIG. 13 is a plan view of the card connector 1 when the card C is not inserted, and FIG. 14 is a plan view of the card connector 1 when the card C is inserted into a specified position.

As is shown in FIGS. 11A and 13, prior to the insertion of the card C, the engagement part 21a of the pivoting arm 21 is positioned to the rear. Furthermore, the push bar 22, push rod 23, push button 24, and push plate 26 are positioned on the rear, and the cam pin 26b provided on the push plate 26 is positioned in the rear side recessed part 27a of the cam groove 27 that is formed in the guide arm 12 as shown in FIG. 11A. The push button 24 does not protrude from the housing. At this point, as is shown in FIG. 13, the rear end portion of the push rod 23 contacts the stop shoulder 57 of the movement restricting member 50, so that the movement of the push rod 23, push bar 22, and push plate 26 toward the rear (i.e., in the card insertion direction) is restricted. Moreover, as a result of the cam pin 26b being positioned in the rear side recessed part 27a, the forward movement of the push plate 26, push bar 22, and push rod 23 is blocked. In other words, when the card C is not inserted, the movement of the push bar 22, push rod 23, and push plate 26 in the card insertion direction and in the card ejection direction is restricted.

Furthermore, when the card C is inserted into the specified position, the corner portion of the card C makes sliding contact with the inclined tongue 56b of the movement restricting member 50; as a result, the movement restricting member 50 swings in the outward direction with the first projection 47a and second projection 47b being used as the pivot, which releases the restriction on the rearward movement of the push rod 23, push bar 22, and push plate 26 by means of the stop shoulder 57. In the state shown in FIG. 14, the side surface of the card C is in sliding contact with the riser 56a, so that the swinging of the movement restricting member 50 is completed. Thus, the rearward movement of the push rod 23, push bar 22, and push plate 26 is made possible only when the card C is inserted into the specified position, which makes it possible for the cam pin 26b to move along the cam groove 27. Moreover, the restriction on the rearward movement of the push rod 23, push bar 22, and push plate 26 and the release of this restriction are performed by the swinging of the movement restricting member 50 with respect to the bracket 41; accordingly, it is possible to reliably achieve an operation which is such that the push button 24 cannot protrude from the housing unless the card C is inserted into the specified position.

Furthermore, when the insertion of the card C is completed, the contacts of the connector 10 make mating contact with the card C, so that the card C and the circuit board are electrically connected.

Moreover, when the push bar 22 is slightly pushed in order to eject the card C, the cam pin 26b moves along from the rear side recessed part 27a to the third rectilinear part 27f of the cam groove 27 formed in the guide arm 12 as shown in FIG. 11B, so that the push plate 26 pivots with its front side downward and its rear side upward. As a result of the rear side of the push plate 26 pivoting upward, it is possible to avoid the engagement of the engagement part 26a of the push plate 26 with the engagement part 21a of the pivoting arm 21.

In addition, when the pushing of the push bar 22 is stopped after the push plate 26 is caused to retract to the rearmost end position by the pushing of the push bar 22, the push bar 22 and push plate 26 advance (pulling operation of the push bar 22 and push plate 26) by means of the action of the tension spring 25 as shown in FIGS. 11C and 11D. At this point, the cam pin 26b advances along the substantially rectilinear part 27e of the cam groove 27.

Then, the push bar 22 and push plate 26 are located in the frontmost end position. At this point, as is shown in FIG. 11E, the cam pin 26b is positioned in the front side recessed part 27d of the cam groove 27. As a result, the push button 24 protrudes from the housing (not shown in the figures), so that the ejection of the card C becomes possible in the subsequent step. When the cam pin 26b is positioned in the front side recessed part 27d of the cam groove 27, the push plate 26 becomes parallel to the direction of card insertion and removal.

Next, when the push bar 22 is pushed, as is shown in FIG. 7, the push plate 26 retracts, and the cam pin 26b moves rearward along the second rectilinear part 27c of the cam groove 27, so that the push plate 26 slightly pivots with its rear side downward and its front side upward. Furthermore, when the pushing of the push bar 22 is continued, the engagement part 26a of the push plate 26 engages with the engagement part 21a of the pivoting arm 21 (pushing operation of the push bar 22 and push plate 26).

Moreover, when the push bar 22 is further pushed, the push plate 26 retracts as shown in FIG. 12A, and the engagement part 21a of the pivoting arm 21 pivots rearward, so that the inserted card C is slightly ejected toward the front. At this point, the cam pin 26b moves rearward along the second rectilinear part 27c of the cam groove 27.

Then, when the push bar 22 is further pushed, the push plate 26 retracts to the rearmost end position as shown in FIG. 12B, and the pivoting arm 21 pivots further, so that the card C is completely ejected. At this point, the cam pin 26b moves rearward along the second rectilinear part 27c of the cam groove 27, and is located in the rearmost end position.

Furthermore, when the pushing of the push bar 22 is stopped, the push bar 22 and push plate 26 move slightly forward as a result of the action of the tension spring 25, and return to the original state shown in FIGS. 11A and 13. At this point, the cam pin 26b moves forward along the first rectilinear part 27b of the cam groove 27, and is positioned in the rear side recessed part 27a. Moreover, the movement restricting member 50 swings in the inward direction with the first projection 47a and second projection 47b being used as the pivot, and returns to the original position, thus restricting the rearward movement of the push rod 23, push bar 22, and push plate 26.

In the embodiment of the present invention, the card ejection mechanism 20 comprises a pivoting arm 21 that is disposed in the connector 10 in a pivotable manner and that ejects the card C in the removal direction as a result of pivoting, a push bar 22 that has a push button 24 and that is capable of moving in the card insertion and removal directions along the side surface of the guide arm 12, and a push plate 26 that is shaft-supported on the push bar 22 in a pivotable manner and that pushes and causes the pivoting arm 21 to pivot during the ejection of the card C. Accordingly, the push plate 26 is pushed by the pushing operation of the push bar 22 that has the push button 24, which causes the pivoting arm 21 to pivot, thus making it possible to eject the card C.

Furthermore, a cam mechanism is provided which consists of a heart-shaped cam groove 27 that is formed in the side surface of the guide arm 12 and a cam pin 26b that is provided on the push plate 26 and that engages with the cam groove 27. Accordingly, this cam mechanism makes it possible to provide a compact card connector 1 that has an ejection function enabling a so-called push push operation.

Moreover, a movement restricting mechanism 40 for the push bar is provided which allows the movement of the cam pin 26b along the cam groove 27 when the card C is inserted into the specified position, and this movement restricting mechanism 40 comprises a bracket 41 that is attached to the guide arm 12 and a movement restricting member 50 that is attached to the bracket 41 in a manner allowing swinging with respect to this bracket 41, so that the movement of the push bar 22 is restricted when the card C is not inserted, and so that this restriction on the movement of the push bar 22 is released as a result of swinging when the card C is inserted into the specified position. Accordingly, it is possible to reliably achieve an operation which is such that the push button 24 cannot protrude from the housing unless the card C is inserted into the specified position.

An embodiment of the present invention was described above. However, the present invention is not limited to this embodiment; various alterations or modifications may be made.

For example, the movement restricting member 50 is designed to restrict the movement of the push bar 22 toward the rear (i.e., in the card insertion direction) when the card C is not inserted. However, the restriction is not limited to this direction; this member 50 may also be devised so that the movement of the push bar 22 in both directions, i.e., toward the front (card ejection direction), and toward the rear (card insertion direction), is restricted when the card C is not inserted. In this case, the movement restricting member 50 is designed to swing when the card C is inserted into a specified position, so that the restriction on the movement of the push bar 22 both in the forward and rearward directions is released.

Furthermore, as long as the card connector performs a so-called push push operation, it is not absolutely necessary to install the push plate 26 or the cam mechanism consisting of the cam groove 27 and cam pin 26b. In this case, the movement restricting member 50 is devised so that the movement of the push bar 22 is restricted in both directions, i.e., toward the front (card ejection direction) and toward the rear (card insertion direction), when the card C is not inserted, and so that this restriction on the movement of the push bar 22 in both forward and rearward directions is released as a result of swinging this member 50 when the card C is inserted into the specified position.

What is claimed is:

1. A card connector comprising:
a connector having a guide arm for guiding a card on insertion and removal;
a card ejection mechanism for ejecting the card from the connector by means of a push push operation, the card ejection mechanism having a pivoting arm that is disposed in the connector in a pivotable manner to eject the card in the removal direction as a result of pivoting, a push bar that has a push button and is capable of moving in the card insertion and removal directions along the side surface of the guide arm, and a push plate that is shaft supported on the push bar in a pivotable manner to push and cause the pivoting arm to pivot during the ejection of the card,
a cam mechanism consisting of a heart-shaped cam groove that is formed in the side surface of the guide arm and a cam pin that is provided on the push plate and that engages with the cam groove; and
a movement restricting mechanism (for the push bar) for allowing the movement of the cam pin along the cam groove when the card is inserted into a specified position, the movement restricting mechanism having a bracket that is attached to the guide arm, and a movement restricting member that is attached to the bracket in a manner allowing swinging with respect to the bracket, so that the movement of the push bar is restricted when the card is not inserted, and so that the restriction on the movement of the push bar is released as a result of swinging when the card is inserted into the specified position.

2. A card connector comprising:
a connector having a guide arm for guiding a card on insertion and removal;
a card ejection mechanism for ejecting the card from the connector by means of a push push operation, the card ejection mechanism having a pivoting arm that is disposed in the connector in a pivotable manner to eject the card in the removal direction as a result of pivoting, and a push bar that has a push button and is capable of moving in the card insertion and removal directions along the side surface of the guide arm; and
a movement restricting mechanism for the push bar which allows the movement of the push bar when the card is inserted into a specified position, the movement restricting mechanism having a bracket that is attached to the guide arm, and a movement restricting member that is attached to the bracket in a manner allowing swinging with respect to the bracket, so that the movement of the push bar is restricted when the card is not inserted, and so that the restriction on the movement of the push bar is released as a result of swinging when the card is inserted into the specified position.
